(19) United States
(12) Patent Application Publication
(10) Pub. No.: US 2022/0283833 A1
(43) Pub. Date: Sep. 8, 2022

(54) SPP SERVER, VIRTUAL MACHINE CONNECTION CONTROL SYSTEM, SPP SERVER CONNECTION CONTROL METHOD AND PROGRAM

(71) Applicant: Nippon Telegraph and Telephone Corporation, Tokyo (JP)

(72) Inventors: Yasufumi Ogawa, Musashino-shi, Tokyo (JP); Naoki Takada, Musashino-shi, Tokyo (JP)

(21) Appl. No.: 17/624,932

(22) PCT Filed: Jul. 9, 2019
(86) PCT No.: PCT/JP2019/027130

§ 371 Date: Jan. 5, 2022

(51) Int. Cl. G06F 9/455

(52) U.S. Cl. CPC G06F 9/45533

(57) ABSTRACT

The SPP server 100 includes: an SPP 160 which controls a reference destination in a memory space of a plurality of virtual machines; a scenario management unit 110 which acquires a scenario definition 50 defining typical performance verification procedures as scenarios by a series of scripts; a scenario execution unit 120 which executes a command using the scenario definition 50 managed by the scenario management unit 110; a server information collection unit 130 which receives an instruction from the scenario execution unit 120 and issues a command for collecting hardware information of a setting target set by the SPP 160; and a profile unit 140 which acquires measurement data of a measurement item when verifying performance using the scenario definition 50 managed by the scenario management unit 110.

### TECHNICAL FIELD

The present invention relates to an SPP server, a virtual machine connection control system, an SPP server connection control method and a program.

### BACKGROUND ART

Supported by progress of virtualization technology by NFV (Network Functions Virtualization) and the like, a system has been constructed and operated for each service. In addition, from the form of constructing a system for each service, a form called SFC (Service Function Chaining) of performing utilization as needed like components and improving operability by dividing service functions into reusable module units and operating them on an independent virtual machine (VM: Virtual Machine or container or the like) environment is becoming mainstream (see Non-Patent Literature 1).

A method of connecting and linking a plurality of virtual machines (appropriately abbreviated as VMs hereinafter) is called Inter-VM Communication, and a virtual switch has been standardly utilized for inter-VM connection in a large-scale environment of a data center or the like. However, since it is a method with great communication delay, faster methods have been newly proposed. For example, a method of using special hardware called SR-IOV (Single Root I/O Virtualization) and a method by software using Intel DPDK (Intel Data Plane Development Kit) (referred to as DPDK hereinafter) which is a high speed packet processing library or the like have been proposed (see Non-Patent Literature 2). The DPDK makes it possible to substantially improve performance and throughput of packet processing and secure a lot of time for data plane applications.

The DPDK exclusively uses computer resources of a CPU (Central Processing Unit) and an NIC (Network Interface Card) or the like. Therefore, it is not easily applied to a purpose of flexible switching in module units like the SFC. As an application for mitigating it is an SPP (Soft Patch Panel) (see Non-Patent Literature 3). The SPP omits packet copying in a virtualization layer by preparing a shared memory among the VMs and enabling the individual VMs to directly refer to the same memory space. In addition, for packet exchange between a physical NIC and the shared memory, the DPDK is used and acceleration is achieved. The SPP can change an input destination and an output destination of packets in terms of software by controlling a reference destination of memory change of the individual VMs. In such a manner, the SPP achieves dynamic connection switch between the VMSs and between the VM and the physical NIC.

FIG. 11 is a diagram describing an outline of the SPP, a sign 1000 is the hardware block diagram, and a sign 1100 is a conceptual diagram of resource management of the SPP. As illustrated by the sign 1000 in FIG. 11, an inter-VM connection device 10 including an SPP 20 is a server which connects individual VMs 5 and an external network 6. The inter-VM connection device 10 includes physical ports 7, the SPP 20 controlled by an SPP controller 20a, a router 8, and VMs 5. Note that the VMs 5 may be provided outside the inter-VM connection device 10. The SPP 20 is a framework for managing DPDK resources, and is configured from a DPDK application in charge of resource management. The SPP 20 is an inter-VM connection function based on the DPDK, and transfer processing can be performed at an extremely high speed compared to a conventional disguise switch product.

The SPP controller 20a is operated by a command line 31 from a control terminal device (Control Terminal) 30. The SPP controller 20a performs resource allocation and routing for connecting the VMs on a basis of connection control by the command line 31.

In the resource management in the SPP illustrated by the sign 1100 in FIG. 11, the physical ports 7 are expressed by “NIC (Network Interface Card)”, an example of allocation of virtual NW resources of the SPP 20 is expressed by “ivshmem, vhost, vSwitch”, the VM 5 is expressed by “VM”, and connection (routing) of the “NIC”, the virtual NW resource “ivshmem, vhost, vSwitch” and the “VM” is expressed. The SPP 20 can flexibly perform the SFC while maintaining rapidity of the DPDK.

### CITATION LIST

### Non-Patent Literature

Non-Patent Literature 1: Internet Engineering Task Force (IETF), J. Halpern, Ed. Ericsson, C. Pignataro, Ed. Cisco, October 2015. Service Function Chaining (SFC) Architecture”, [online], [Retrieved on Jun. 20, 2019], Internet <URL: https://www.ietf.org/rfc/rfc7665.txt>
Non-Patent Literature 2: IntelDPDK, [online], [Retrieved on Jun. 20, 2019], Internet <URL: http://dpdk.org/>
Non-Patent Literature 3: Soft Patch Panel, [online], [Retrieved on Jun. 20, 2019], Internet <URL: http://dpdk.org/browse/apps/spp/>

### SUMMARY OF THE INVENTION

### Technical Problem

However, for the DPDK and the SPP, performance tuning is difficult, and parameters are set in consideration of hardware configuration of a CPU, a memory and various kinds of components or the like as illustrated by the sign 1000 in FIG. 11. In addition, the DPDK and the SPP have the problem that it is difficult to reproduce a verification since procedures are detailed and complicated.

For example, in the DPDK application of the SPP or the like, a core and a memory or the like to be used need to be specified by parameters (on the premise that an application user knows an optimum value beforehand). Actually, tuning needs to be performed while recognizing a layout of the core and the memory (hyperthread utilization propriety, CPU architecture and layout, whether or not to extend over a bus, the number of channels and the number of clocks or the like for the memory) and adjusting the parameters. In this case, since examinations have to be performed one by one by a command or the like, there is the problem that it is extremely time-consuming.

The present invention is implemented in consideration of such a background, and an object of the present invention is to reduce labor and time of a performance verification in an SPP and improve reproducibility of verification testing.

### Means for Solving the Problem

In order to solve the problem described above, the present invention is an SPP server including: an SPP (Soft Patch Panel) configured to control a reference destination in a memory space of a plurality of virtual machines; a scenario management unit configured to acquire a scenario definition defining typical performance verification procedures as scenarios by a series of scripts; a scenario execution unit configured to execute a command using the scenario definition managed by the scenario management unit; an information collection unit configured to receive an instruction from the scenario execution unit and issue a command for collecting hardware information of a setting target set by the SPP; and a measurement data acquisition unit configured to acquire measurement data of a measurement item when verifying performance using the scenario definition managed by the scenario management unit.

### Effects of the Invention

According to the present invention, labor and time of a performance verification in an SPP can be reduced, and reproducibility of verification testing can be improved.

### BRIEF DESCRIPTION OF DRAWINGS

FIG. 1 is a block diagram illustrating a virtual machine connection control system relating to an embodiment of the present invention.

FIG. 2 is a diagram illustrating an example of a scenario definition prepared by a user of an SPP server relating to the embodiment of the present invention.

FIG. 3 is a diagram illustrating an example of an operation displayed on a display screen of a user terminal of the SPP server relating to the embodiment of the present invention.

FIG. 4 is a diagram illustrating a scenario managed by a scenario management unit of the SPP server relating to the embodiment of the present invention.

FIG. 5 is a control sequence of the SPP server relating to the embodiment of the present invention.

FIG. 6 is a diagram illustrating an example of display on an operation screen of the SPP server relating to the embodiment of the present invention.

FIG. 7 is a diagram illustrating a configuration view of the operation screen of the SPP server relating to the embodiment of the present invention.

FIG. 8 is a diagram illustrating the configuration view of the operation screen of the SPP server relating to the embodiment of the present invention.

FIG. 9 is a diagram illustrating a capture referred to from a setting/log reference command history on the operation screen of the SPP server relating to the embodiment of the present invention.

FIG. 10 is a schematic block diagram of a virtual machine connection control system for which an arithmetic device specialized in specific processing is added to a general-purpose computer.

FIG. 11 is a diagram describing an outline of an SPP, a sign 1000 is a hardware block diagram thereof, and a sign 1100 is a conceptual diagram of resource management of the SPP.

### DESCRIPTION OF EMBODIMENTS

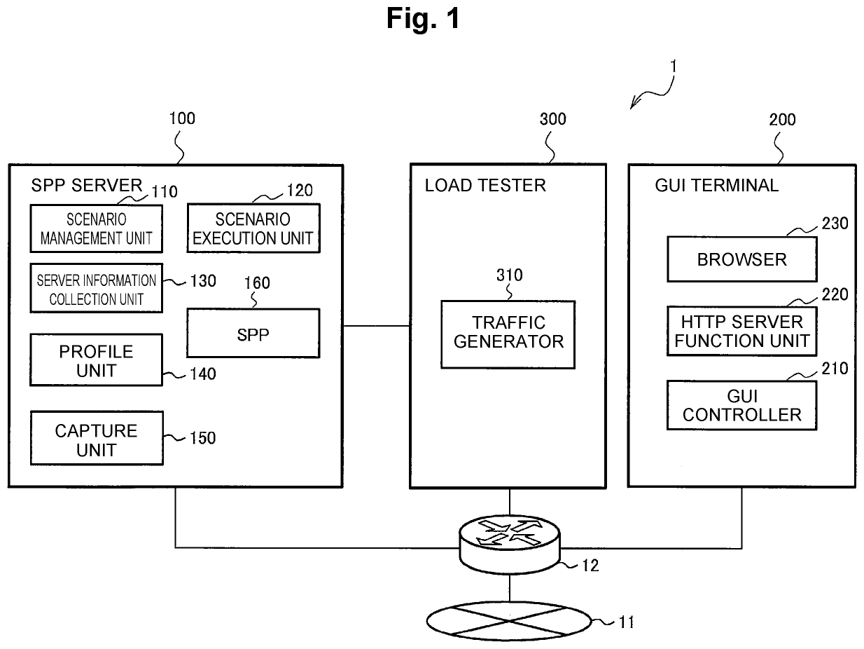

Hereinafter, a virtual machine connection control system or the like in an embodiment (referred to as “present embodiment” hereinafter) of the present invention will be explained with reference to the drawings. FIG. 1 is a block diagram illustrating the virtual machine connection control system relating to the embodiment of the present invention. A virtual machine connection control system 1 of the present embodiment is an example applied to an SFC of performing utilization as needed like components and improving operability by dividing service functions into reusable module units and operating a virtual machine on an independent environment.

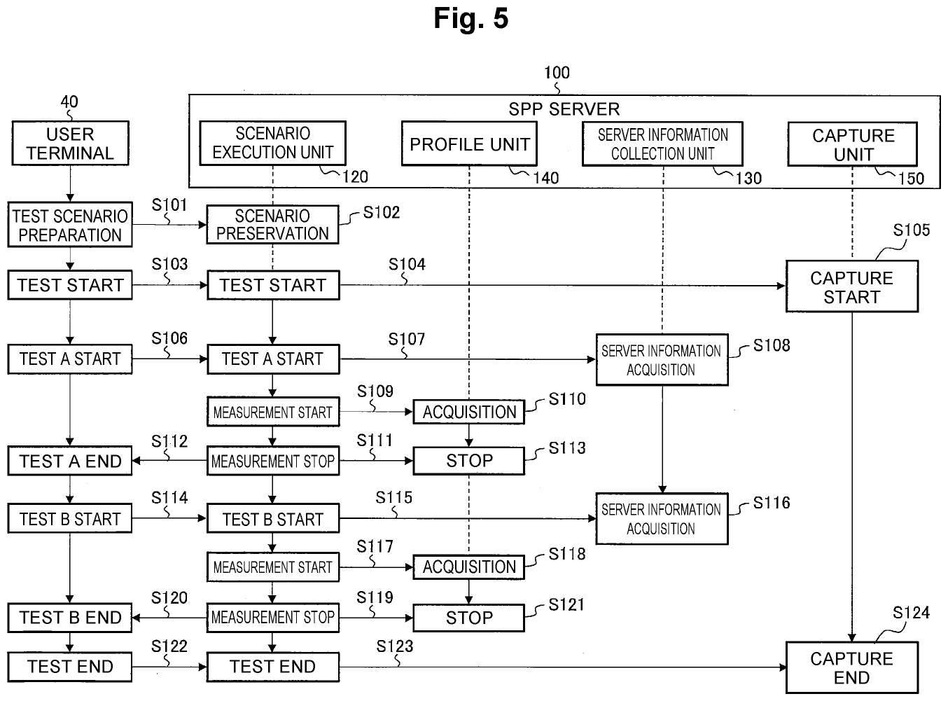

As illustrated in FIG. 1, the virtual machine connection control system 1 includes an SPP server 100 provided with an SPP (Soft Patch Panel) which controls a reference destination in a memory space of a plurality of virtual machines, and a GUI (Graphical User Interface) terminal 200. In the present embodiment, a load tester 300 is connected to the virtual machine connection control system 1. The SPP server 100 and the GUI terminal 200 are connected through a router 12, and the router 12 is connected to a network 11 formed of a WAN (Wide Area Network) for example. The SPP server 100 is connected to the network 11 at a back-end. In addition, to the SPP server 100, a non-illustrated user terminal 40 (see FIG. 5) is connected directly or via the network 11.

<SPP Server>

The SPP server 100 includes a scenario management unit 110, a scenario execution unit 120, a server information collection unit 130 (information collection unit), a profile unit 140 (measurement data acquisition unit), a capture unit 150, and an SPP 160. The scenario management unit 110 acquires a scenario definition defining typical performance verification procedures as scenarios by a series of scripts.

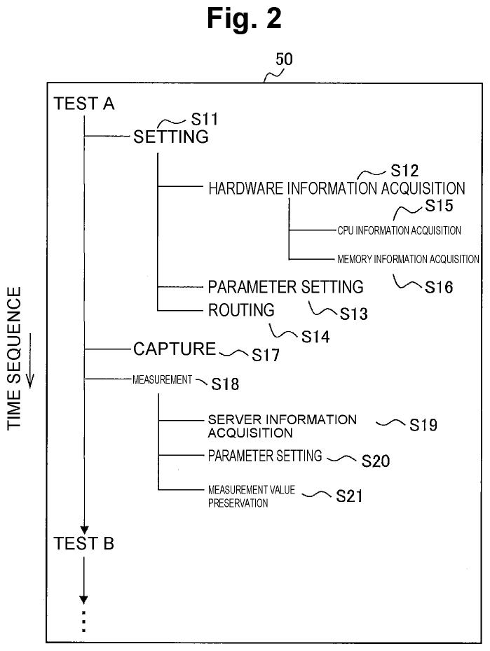

Then, the scenario management unit 110 manages a scenario definition 50 (see FIG. 2) prepared by the user terminal 40 as an XML (Extensible Markup Language). The scenario management unit 110 associates the scenario and an operation menu.

The scenario execution unit 120 executes a command using the scenario definition 50 managed by the scenario management unit 110.

When an item is executed from the operation menu, the scenario execution unit 120 automatically executes processing based on the scenario according to an XML definition for which the scenario definition 50 is managed as the XML. The scenario execution unit 120 analyzes the XML and executes each command.

The server information collection unit 130 receives an instruction from the scenario execution unit 120, and issues a command for collecting hardware information of a setting target set by the SPP 160. For example, for information collection, a command for performing sampling is issued.

As described above, in a DPDK application of the SPP or the like, tuning needs to be performed while recognizing a layout of a core and a memory to be used (hyperthread utilization propriety, CPU architecture and layout, whether or not to extend over a bus, the number of channels and the number of clocks or the like for the memory) and adjusting parameters. The server information collection unit 130 can reduce each examination by the command as the entire system by combining the command issuance with the scenario definition 50.

The profile unit 140 acquires measurement data of a measurement item when verifying performance using the scenario definition 50 managed by the scenario management unit 110. The profile unit 140 acquires data to be measured (time-sequential data of throughput and delay response data corresponding to the time-sequential data) other than a log or the like.

The capture unit 150 captures the command issued by the user terminal, the log and an operation screen by moving images, on the basis of a capture procedure described by the scenario definition 50.

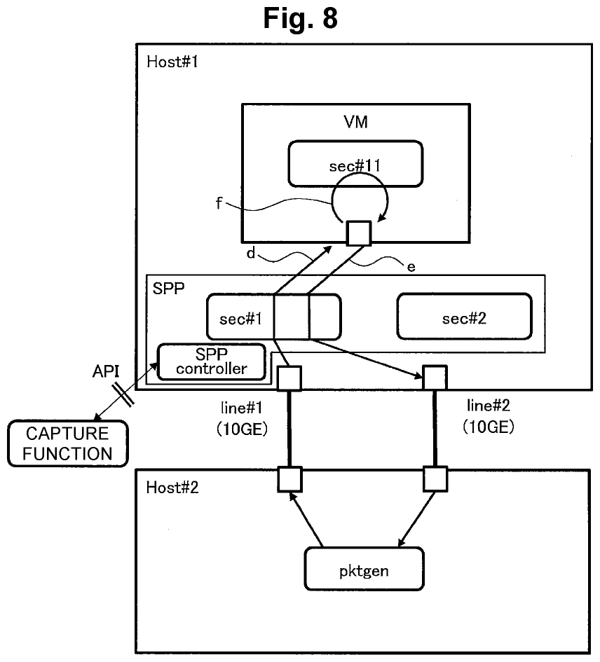

The capture unit 150 acquires and stores the command manually issued by a user and the log via an API (Application Program Interface) (see a sign=in FIG. 8) provided in the SPP controller. The capture unit 150 captures the command manually issued by the user, the log and the operation screen by the moving images.

Note that detailed data such as the measurement data is acquired by the profile unit 140, and a situation that the user is roughly viewing and the log (event log) which is not the data are captured by the capture unit 150.

The SPP 160 controls the reference destination in the memory space of the plurality of virtual machines. Then, the SPP 160 manages resources (NIC, ring) of the SPP including the virtual machines, a port object and a VM object.

<GUI Terminal>

The GUI terminal 200 cooperates with the SPP server 100 and performs resource allocation and routing for connecting the virtual machines by a GUI operation. The GUI terminal 200 includes a GUI controller 210, an HTTP (Hyper Text Transfer Protocol) server function unit 220, and a browser 230. The GUI controller 210 presents information on a screen by a graphic element, and controls the GUI operation of instructing a position and a movement on the screen by a pointing device.

The HTTP server function unit 220 provides the information stored in the GUI terminal 200 in response to an HTTP request transmitted from a client through the Internet or the like.

The browser 230 displays the information of a webpage on the Internet on the screen

<Load Tester>

The load tester 300 executes a performance verification by the SPP server. The load tester 300 uses pktgen (R) as a traffic generator 310. The pktgen is a packet generator which utilizes the DPDK, and can transmit packets in a plurality of patterns.

Hereinafter, an operation of the SPP server 100 of the virtual machine connection control system 1 configured as described above will be explained.

<Scenario Definition Preparation>

FIG. 2 is a diagram illustrating an example of the scenario definition 50 prepared by the user.

The scenario is defined by the user with the typical verification procedures as a series of scripts (the scenario defined by the user is referred to as the scenario definition 50). The scenario definition 50 defines automation items for executing a typical verification (performance measurement, testing). By using the scenario definition 50, loads of work which is complicated and needs two or more times of testing such as performance tuning are reduced (to be described later).

As illustrated in FIG. 2, the scenario definition 50 is time-sequentially described for a test A, a test B . . . which are the typical verification procedures.

The test A and the test B are test scenarios indicating the verification procedures of the work which is complicated and needs two or more times of testing such as performance tuning. The verification procedures are made time-sequential so as to advance to the test B after the test A.

In step S11, the user is made to set the test A of registering the test scenario according to guidance by the user terminal 40 (see FIG. 5) connected to the SPP server 100 (see FIG. 1). To the user terminal 40, a command for registering the test scenario is set beforehand. The user terminal 40 receives an operation by the user, specifies the command, and makes the test scenario indicated in step S121-step S16 below be automatically registered.

In step S12, the user terminal 40 (see FIG. 5) describes the scenario for the SPP server 100 to acquire the hardware information, the scenario for the SPP server 100 to set the parameters in step S13, and the scenario for the SPP server 100 to set a route in step S14.

In hardware information acquisition in step S12 described above, the user terminal 40 further describes the scenario for acquiring CPU information in step S15 and the scenario for acquiring memory information in step S16.

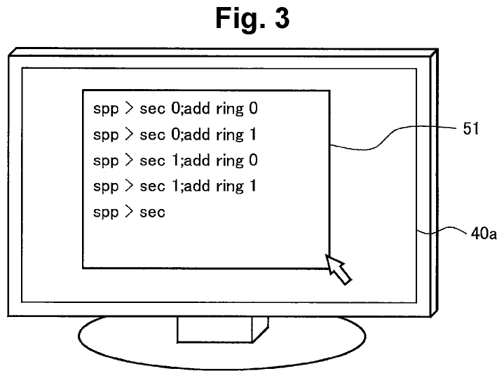

FIG. 3 is a diagram illustrating an example of an operation displayed on a display screen 40a of the user terminal 40.

As illustrated in FIG. 3, when describing the scenarios in step S11-step S16, an execution operation 51 based on a command operation by the user is displayed as a moving image.

In order to set a network route of the scenarios in FIG. 2, the command in FIG. 3 is inputted. A description method of the command input is based on specifications of the SPP in Non-Patent Literature 3. Note that, in the command below, sec is a Secondary process, and describes processes VNF, FWD in the SPP. In addition, the connection of the scenarios in FIG. 2 is set.

Returning to FIG. 2, in step S17, the user terminal 40 describes a capture for the test A.

In step S18, the user terminal 40 describes measurement for the test A. In the measurement in step S18, the scenario for acquiring server information in step S19, the scenario for setting the parameters in step S20 and the scenario for preserving a measurement value in step S21 are described further. That ends description of the test scenarios for the test A, and then the description of the test scenarios for the test B is started.

While step numbers are attached to the scenario definition 50 illustrated in FIG. 2 above for convenience of explanation, the scenario definition 50 illustrated in FIG. 2 without the step numbers is actually the test scenario prepared by the user.

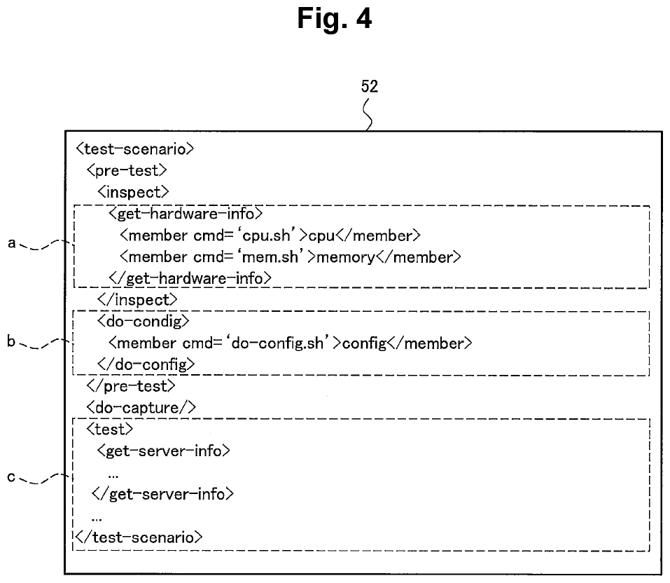

FIG. 4 is a diagram illustrating the scenario managed by the scenario management unit 110 of the SPP server 100.

The scenario management unit 110 (see FIG. 1) manages the scenario definition 50 (see FIG. 2) prepared by the user terminal 40 as the XML (Extensible Markup Language).

FIG. 4 is the diagram illustrating an example of a scenario 52 managed as the XML by the scenario management unit 110.

A part indicated by a sign (a) in FIG. 4 describes data of “setting” in the scenario definition 50 (see FIG. 2).

A part indicated by a sign b in FIG. 4 describes data of “routing” in the scenario definition 50 (see FIG. 2).

A part indicated by a sign c in FIG. 4 describes data of “test start” in the scenario definition 50 (see FIG. 2). Note that the description of the data of “test start” is omitted in the scenario definition 50 (see FIG. 2).

FIG. 5 is a control sequence of the SPP server 100 of the virtual machine connection control system 1.

As illustrated in FIG. 5, the user terminal 40 prepares the test scenario (scenario definition 50 (see FIG. 2)), and transmits the test scenario to the scenario execution unit 120 (step S101).

The scenario management unit 110 manages the test scenario prepared by the user terminal 40 as the XML. The scenario execution unit 120 preserves the test scenario described by the XML (step S102).

The user terminal 40 transmits test start to the scenario execution unit 120 by executing the item from the operation menu (step S103).

The scenario execution unit 120 automatically executes processing based on the scenario according to the XML definition, on a basis of the preserved scenario. That is, the scenario execution unit 120 executes calling to individual units corresponding to the instruction of the scenario. Here, the scenario execution unit 120 starts a test and instructs capture start to the capture unit 150 (step S104).

The capture unit 150 starts capture of capturing the command manually issued by the user, the log and the operation screen by moving images (step S105). The capture unit 150 acquires and stores the command manually issued by the user and the log via the API (see the sign=in FIG. 8) provided in the SPP controller.

Note that the capture is continued until the series of tests ends (step S124).

The user terminal 40 transmits test (the test A (see FIG. 2) here) start to the scenario execution unit 120 by executing the item from the operation menu (step S106).

The scenario execution unit 120 starts the processing of the test A based on the scenario according to the XML definition on the basis of the preserved scenario definition 50, and transmits processing start of the test A to the server information collection unit 130 (step S107).

The server information collection unit 130 receives the instruction from the scenario execution unit 120, issues the command for collecting the hardware information in the test A, and acquires the hardware information (server information) of the test A (step S108). Note that the hardware information (server information) acquisition is continued until the series of tests ends (step S116).

Here, the server information collection unit 130 combines the command issuance in the test A with the scenario definition 50 provided from the scenario execution unit 120 and thus each examination by the command is substantially reduced.

The scenario execution unit 120 starts the measurement in the test A, and notifies the profile unit 140 (step S109).

The profile unit 140 acquires the data to be measured (for example, the time-sequential data of the throughput and the delay response data corresponding to the time-sequential data, regarding the test A) as a profile of the test A (step S110).

When the measurement of the test A ends, the scenario execution unit 120 notifies the profile unit 140 of measurement end of the test A (step S111), and transmits the end of the test A to the user terminal 40 (step S112).

The profile unit 140 stops the acquisition of the data to be measured (profile) (step S113).

The user terminal 40 is notified of the end of the test A, and transmits next test (the test B (see FIG. 2) here) start to the scenario execution unit 120 by executing the item from the operation menu (step S114).

The scenario execution unit 120 starts the processing of the test B based on the scenario according to the XML definition on the basis of the preserved scenario, and transmits the processing start of the test B to the server information collection unit 130 (step S115).

The server information collection unit 130 receives the instruction from the scenario execution unit 120, issues the command for collecting the hardware information in the test B, and acquires the hardware information (server information) of the test B (step S116). Here, the server information collection unit 130 combines the command issuance in the test B with the scenario definition 50 provided from the scenario execution unit 120 and thus each examination by the command is substantially reduced.

The scenario execution unit 120 starts the measurement in the test B, and notifies the profile unit 140 (step S117).

The profile unit 140 acquires the data to be measured (for example, the time-sequential data of the throughput and the delay response data corresponding to the time-sequential data, regarding the test B) as the profile of the test B (step S118).

When the measurement of the test B ends, the scenario execution unit 120 notifies the profile unit 140 of the measurement end of the test B (step S119), and transmits the end of the test B to the user terminal 40 (step S120).

The profile unit 140 stops the acquisition of the data to be measured (profile) (step S121).

The user terminal 40 is notified of the end of a series of the test B, and transmits the next test end to the scenario execution unit 120 by executing the item from the operation menu (step S122).

The scenario execution unit 120 executes test end processing, and notifies the capture unit 150 (step S123). The capture unit 150 ends the capture (step S124).

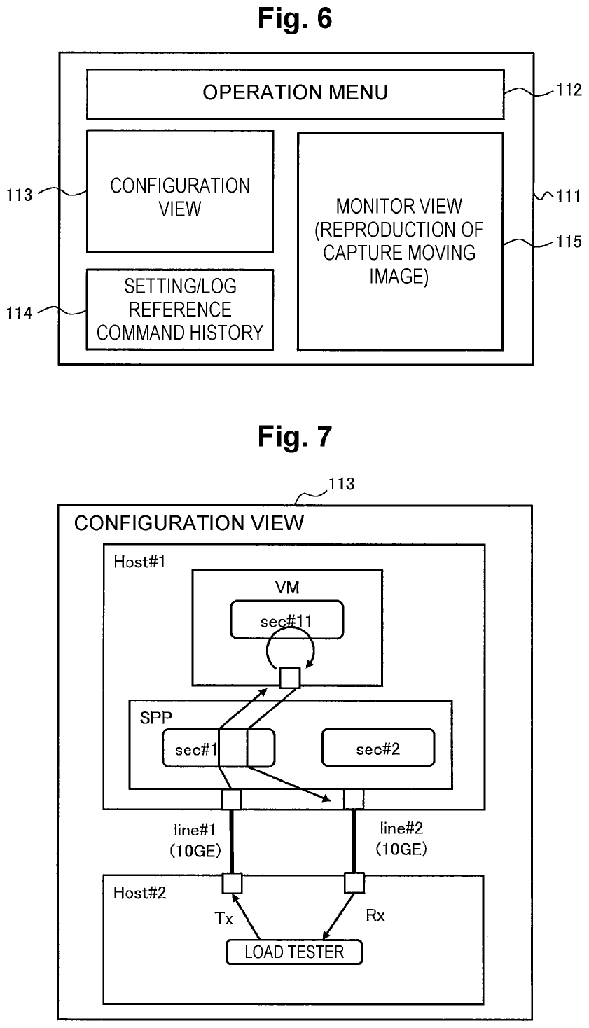

FIG. 6-FIG. 8 are diagrams explaining an implementation image of load testing in the SPP. FIG. 6 is a diagram illustrating an example of display on an operation screen 111 of the SPP server 100. FIG. 7 is a diagram illustrating the configuration view 113. FIG. 8 is a diagram illustrating the monitor view 115.

As illustrated in FIG. 6, on the operation screen 111 of the SPP server 100, an operation menu 112, the configuration view 113, a setting/log reference command history 114, and the monitor view 115 are displayed.

The SPP server 100 performs dynamic network setting of the SPP, tests and the reproduction through the operation screen.

The configuration view 113 illustrated in FIG. 7 illustrates a load testing example by two hosts (Host #1, Host #2). Two counter ports (Tx, Rx) for input/output are connected, and the throughput of the SPP and the VM in the Host #1 is measured. In addition, sec 1 or the like is an identifier of a process in charge of packet transfer between routes.

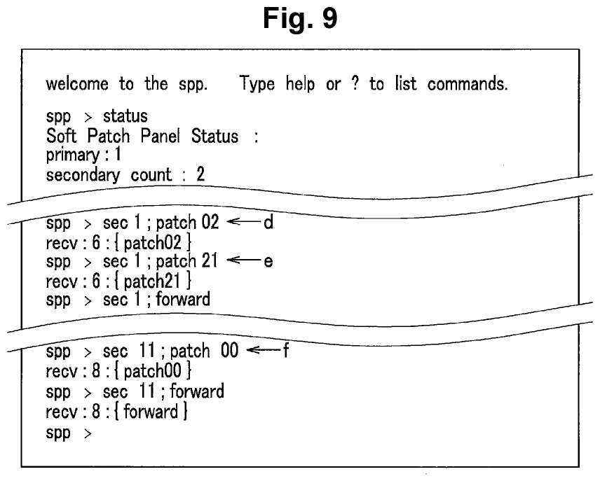

FIG. 8 and FIG. 9 are diagrams explaining an implementation image of a network setting example in the SPP. FIG. 8 is the diagram illustrating the configuration view 113 on the operation screen 111 of the SPP server 100 in FIG. 6. FIG. 9 is a diagram illustrating a capture referred to from the setting/log reference command history 114 on the operation screen 111 of the SPP server 100 in FIG. 6.

FIG. 8 illustrates a setting example of a network route in the Host #1 in FIG. 7. In the SPP, a shared memory is prepared among the plurality of virtual machines and each virtual machine is made to directly refer to the same memory space. In such a manner, the reference destination in the memory space of the plurality of virtual machines is controlled, and the routing is performed by connecting (patching) endpoints (ports) by the command.

As illustrated in FIG. 9, the capture unit 150 acquires and stores the command manually issued by the user and the log via the API (Application Programming Interface) (see FIG. 8) provided in the SPP controller.

For example, the route indicated by a sign d in FIG. 8 is set on the basis of “sec 1; patch 02” of the captured log indicated by the sign d in FIG. 9. The route indicated by a sign e in FIG. 8 is set on the basis of “sec 1; patch 21” of the captured log indicated by the sign e in FIG. 9. The route indicated by a sign f in FIG. 8 is set on the basis of “sec 1; patch 00” of the captured log indicated by the sign f in FIG. 9.

In such a manner, hardware information acquisition, parameter setting and routing or the like can be automated. Automatable procedures are systemized, and reproducibility is improved by logging and capture for parts to be manually performed.

[Hardware Configuration]

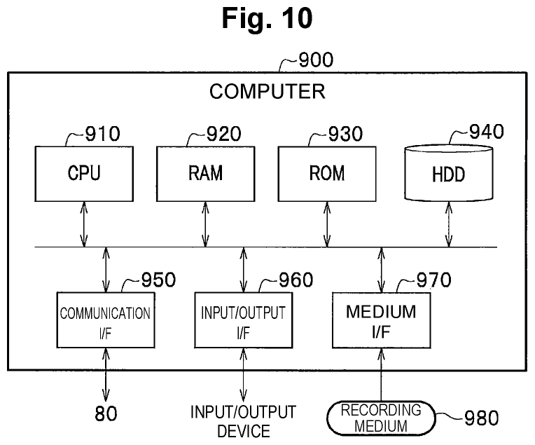

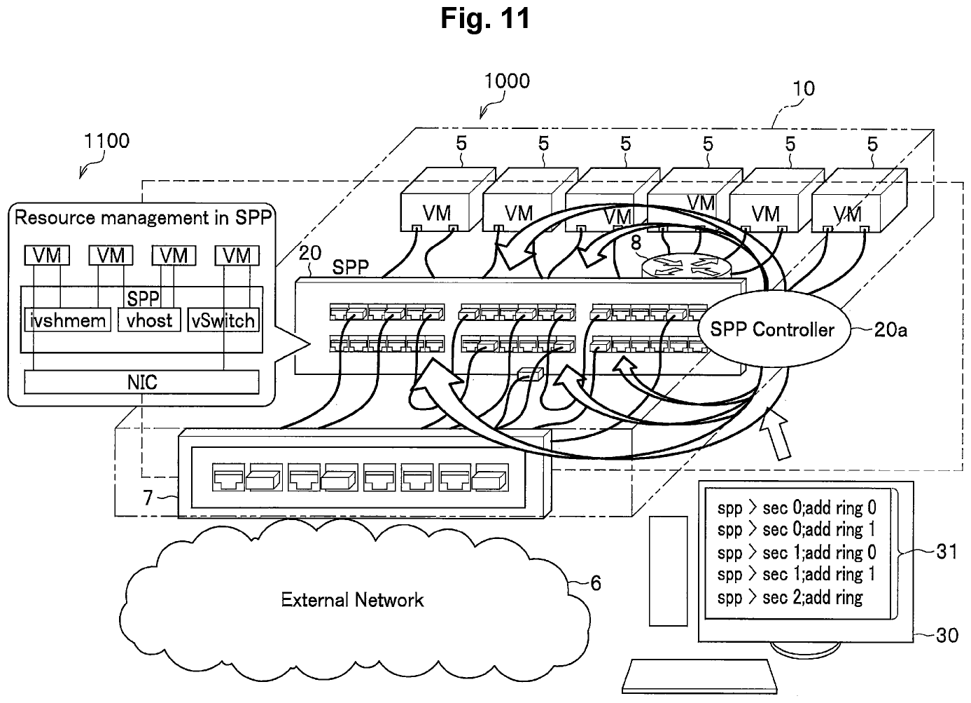

The SPP server 100 relating to the present embodiment is implemented by a computer 900 configured as illustrated in FIG. 10 for example. Hereinafter, the SPP server 100 will be explained as an example. FIG. 10 is a hardware block diagram illustrating an example of the computer 900 which implements functions of the SPP server 100.

The computer 900 includes a CPU 910, a RAM 920, a ROM 930, an HDD 940, a communication interface (I/F) 950, an input/output interface (I/F) 960, and a medium interface (I/F) 970.

The CPU 910 is operated on the basis of a program stored in the ROM 930 or the HDD 940, and controls the individual units. The ROM 930 stores a boot program executed by the CPU 910 at activation of the computer 900 and a program which depends on hardware of the computer 900 or the like.

The HDD 940 stores the program executed by the CPU 910 and data used by the program or the like. The HDD 940 may be a DB used by the server information collection unit 130 (see FIG. 1) for example. The communication interface 950 receives data from another apparatus through a communication network 80, and transmits the data generated by the CPU 910 to the other apparatus through the communication network 80.

The CPU 910 controls an output device such as a display and a printer and an input device such as a keyboard and a mouse through the input/output interface 960. The CPU 910 acquires data from the input device through the input/output interface 960. In addition, the CPU 910 outputs the generated data to the output device through the input/output interface 960.

The medium interface 970 reads the program or the data stored in a recording medium 980, and provides the CPU 910 with the program or the data through the RAM 920. The CPU 910 loads the program from the recording medium 980 onto the RAM 920 through the medium interface 970, and executes the loaded program. The recording medium 980 is, for example, an optical recording medium such as a DVD (Digital Versatile Disc) or a PD (Phasechangerewritable Disk), a magneto-optical recording medium such as an MO (Magneto Optical disk), a tape medium, a magnetic recording medium or a semiconductor memory.

For example, in a case where the computer 900 functions as the SPP server 100 relating to the present embodiment, the CPU 910 of the computer 900 implements the functions of the individual units of the SPP server 100 by executing the program loaded onto the RAM 920. In addition, in the HDD 940, the data inside the individual units of the SPP server 100 is stored. The CPU 910 of the computer 900 reads and executes the programs from the recording medium 980, but may acquire the programs from another device through the communication network 80 as another example.

[Effect]

As described above, the SPP server 100 (see FIG. 1) relating to the present embodiment includes: the SPP 160 which controls the reference destination in the memory space of the plurality of virtual machines; the scenario management unit 110 which acquires the scenario definition 50 (see FIG. 2) defining the typical performance verification procedures as the scenarios by the series of scripts; the scenario execution unit 120 which executes the command using the scenario definition 50 managed by the scenario management unit 110; the information collection unit (server information collection unit 130) which receives the instruction from the scenario execution unit 120 and issues the command for collecting the hardware information of the setting target set by the SPP 160; and the measurement data acquisition unit (profile unit 140) which acquires the measurement data of the measurement item when verifying the performance using the scenario definition 50 managed by the scenario management unit 110.

In such a manner, labor and time of the performance verification in the SPP can be reduced, and the reproducibility of verification testing can be improved.

(1) For example, while there are many tuning items such as the parameter setting regarding hardware and the resource allocation to processes in the verification of the SPP, by preparing the scenario definition 50 as an automation task, the labor can be greatly reduced.

(2) In addition, regarding verification work manually performed by the user, by preparing the scenario definition 50, automation is made possible, the time of the verification can be reduced, and the reproducibility regarding the verification testing can be improved.

That is, in order to perform performance tuning in consideration of the hardware, appropriate parameter needs to be set corresponding to difference of a hardware architecture, however, since the confirmation method and setting method are detailed, a lot of know-how is required to obtain an optimum setting parameter, and work time is needed.

The SPP server 100 unitarily manages the hardware information, a test procedure and a test result regarding the SPP. The SPP server 100 automatically performs setting and the test, and graphically presents the result to the user. Thus, the SPP server 100 can improve test reproducibility and reduce a work cost needed for the performance tuning.

(3) Further, the scenario definition 50 can be applied even when the hardware is changed, and the labor in the case of performing the similar verification in the plurality of machines can be reduced.

(4) The information collection unit (server information collection unit 130) can automatically acquire the required hardware information in cooperation with the scenario. The server information collection unit 130 can reduce each examination by the command as the entire system by combining the command issuance with the scenario definition 50.

(5) The measurement data acquisition unit (profile unit 140) can automatically acquire the data to be measured (the time-sequential data of the throughput and the delay response data corresponding to the time-sequential data) in cooperation with the scenario.

In the SPP server 100, the scenario definition 50 describes a setting procedure of acquiring the hardware information, parameter information and route information, the capture procedure of acquiring the command issued by the user terminal and the log thereof, and a measurement procedure of acquiring the measurement data of the measurement item when verifying the performance, for each test for which the performance verification procedures are made time-sequential.

In such a manner, the SPP server 100 can unitarily manage the hardware information, the test procedure and the test result using the scenario definition 50, and automatically perform the test.

The SPP server 100 includes the capture unit 150 which captures the command manually issued by the user, the log and the operation screen by moving images, on the basis of the capture procedure described by the scenario definition 50.

In such a manner, the capture unit 150 can recognize the situation that the user is viewing by capturing the command manually issued by the user, the log and the operation screen by the moving images. In addition, the measurement item and log collection defined in the scenario can be automatically executed and a verification result can be displayed.

In the SPP server 100, the capture unit 150 acquires and stores the command manually issued by the user and the log via the API provided in the SPP controller.

In such a manner, the capture unit 150 can acquire the command manually issued by the user and the log via the API provided in the SPP controller.

Of the individual processing explained in the embodiment described above, all or part of the processing explained as the one to be automatically performed may be manually performed, or all or part of the processing explained as the one to be manually performed may be automatically performed by a known method. In addition, information including processing procedures, control procedures, specific names, various kinds of data and parameters illustrated in the above-described document and in the drawings can be arbitrarily changed unless otherwise specified.

In addition, individual components of the individual devices illustrated are functionally conceptual, and do not always need to be physically configured as illustrated. That is, specific form of distribution/integration of the individual devices is not limited to the illustration, and the all or part may be functionally or physically distributed/integrated in an arbitrary unit and configured according to various kinds of loads and using situations or the like.

Further, part or all of the individual configurations, functions, processing units and processing means or the like described above may be implemented by the hardware by design in an integrated circuit for example. In addition, the individual configurations and functions or the like described above may be implemented by software for a processor to interpret and execute the programs which implement the respective functions. The information of the programs, tables and files or the like which implements the individual functions can be held in a recording device such as a memory, a hard disk or an SSD (Solid State Drive), or a recording medium such as an IC (Integrated Circuit) card, an SD (Secure Digital) card or an optical disk.

### REFERENCE SIGNS LIST

1 Virtual machine connection control system
11 Network
12 Router
40 User terminal
50 Scenario definition
100 SPP server
111 Display screen
112 Operation menu
113 Configuration view
114 Setting/log reference command history
115 Monitor view
110 Scenario management unit
120 Scenario execution unit
130 Server information collection unit (information collection unit)
140 Profile unit (measurement data acquisition unit)
150 Capture unit
160 SPP
200 GUI terminal
300 Load tester

1. An Soft Patch Panel (SPP) server comprising:
an SPP (Soft Patch Panel), including one or more processors, configured to control a reference destination in a memory space of a plurality of virtual machines;
a scenario management unit, including one or more processors, configured to acquire a scenario definition defining typical performance verification procedures as scenarios by a series of scripts;
a scenario execution unit, including one or more processors, configured to execute a command using the scenario definition managed by the scenario management unit;
an information collection unit, including one or more processors, configured to receive an instruction from the scenario execution unit and issue a command for collecting hardware information of a setting target set by the SPP; and
a measurement data acquisition unit, including one or more processors, configured to acquire measurement data of a measurement item when verifying performance using the scenario definition managed by the scenario management unit.

2. The SPP server according to claim 1,
wherein the scenario definition describes a setting procedure of acquiring the hardware information, parameter information and route information, a capture procedure of acquiring a command issued by a user terminal and a log thereof, and a measurement procedure of acquiring measurement data of the measurement item when verifying the performance, for each test for which the performance verification procedures are made time-sequential.

3. The SPP server according to claim 2, comprising
a capture unit, including one or more processors, configured to capture the command issued by the user terminal, the log and an operation screen by moving images.

4. The SPP server according to claim 3,
wherein the capture unit is configured to acquire and store the command issued by the user terminal and the log via an API (Application Program Interface) provided in the SPP controller.

5. The SPP server according to claim 1,
wherein a GUI (Graphical User Interface) terminal is configured to perform resource allocation and routing for connecting the virtual machines set by the SPP by a GUI operation; and
a load tester, including one or more processors, is configured to execute a performance verification by the SPP server.

6. An SPP server connection control method comprising:
acquiring a scenario definition defining typical performance verification procedures as scenarios by a series of scripts;
executing a command using the scenario definition;
receiving an instruction and issuing a command for collecting hardware information of a setting target set by an SPP (Soft Patch Panel); and
acquiring measurement data of a measurement item when verifying performance using the scenario definition.

7. A non-transitory computer readable medium storing one or more instructions causing a computer as an SPP (Soft Patch Panel) server to execute:
controlling a reference destination in a memory space of a plurality of virtual machines;
acquiring a scenario definition defining typical performance verification procedures as scenarios by a series of scripts;
executing a command using the scenario definition;
receiving an instruction and issuing a command for collecting hardware information of a setting target set by an SPP; and
acquiring measurement data of a measurement item when verifying performance using the scenario definition.

8. The SPP server connection control method according to claim 6,
wherein the scenario definition describes a setting procedure of acquiring the hardware information, parameter information and route information, a capture procedure of acquiring a command issued by a user terminal and a log thereof, and a measurement procedure of acquiring measurement data of the measurement item when verifying the performance, for each test for which the performance verification procedures are made time-sequential.

9. The SPP server connection control method according to claim 8, comprising:
capturing the command issued by the user terminal, the log and an operation screen by moving images.

10. The SPP server connection control method according to claim 9, comprising:
acquiring and storing the command issued by the user terminal and the log via an API (Application Program Interface) provided in the SPP controller.

11. The non-transitory computer readable medium according to claim 7,
wherein the scenario definition describes a setting procedure of acquiring the hardware information, parameter information and route information, a capture procedure of acquiring a command issued by a user terminal and a log thereof, and a measurement procedure of acquiring measurement data of the measurement item when verifying the performance, for each test for which the performance verification procedures are made time-sequential.

12. The non-transitory computer readable medium according to claim 11, wherein the one or more instructions cause the computer to execute:
capturing the command issued by the user terminal, the log and an operation screen by moving images.

13. The non-transitory computer readable medium according to claim 12, wherein the one or more instructions cause the computer to execute:
acquiring and storing the command issued by the user terminal and the log via an API (Application Program Interface) provided in the SPP controller.
